(19) United States
(12) Patent Application Publication
(10) Pub. No.: US 2005/0117076 A1
(43) Pub. Date: Jun. 2, 2005

(54) Restration adjuser and registration adjusting method

(76) Inventors: Yusuke Kawamura, Kanagawa (JP); Shigeyuki Sano, Kanagawa (JP); Mie Hirai, Kanagawa (JP); Toshiyuki Kawashima, Saitama (JP); Seiji Saito, Kanagawa (JP); Ayako Kuroda, Mie (JP)

Correspondence Address: William S Frommer;Frommer Lawrence & Haug, 745 Fifth Avenue, New York, NY, 10151, US

(21) Appl. No.: 10/477,590

(22) PCT Filed: May 16, 2002
(86) PCT No.: PCT/JP02/04752

(30) Foreign Application Priority Data
May 16, 2001 (JP) 2001-147095

(51) Int. Cl. H04N 3/26

(52) U.S. Cl. 348/807; 348/745

(57) ABSTRACT

The present invention provides an apparatus for adjusting registration to correct distortion and color shift of images on a display screen which comprises RAMs (13) and (15) for storing correction data for deflection used to correct scanning positions of image signals for respective plural adjustment points arranged on the display screen along the horizontal direction and the vertical direction, and an Interpolation calculation block (18) for determining the number of interpolation scanning lines being the number of scanning lines which are scanned between the adjustment points corresponding to input image signals as well as for performing interpolation calculation based on the number of interpolation scanning lines for correction waveforms corresponding to display screen position induced from the correction data of the respective adjustment points to generate current signals to be applied to deflection yokes.

### TECHNICAL FIELD

The present invention relates to an apparatus and a method for adjusting registration which are used to correct image distortion etc. raised in a triple-tube type CRT projector using three Cathode-Ray Tubes (CRTs) or the like.

### BACKGROUND ART

There is known a triple-tube type CRT projector using three Cathode-Ray Tubes (CRTs) or a CRT 30R, a CRT 30G, and a CRT 30B which project three primary color images of R signals, G signals, and B signals respectively to form composite images of the R, G, B signals on a screen S, as shown in FIG. 1. In forming the composite images using the triple-tube type CRT projector, since projection positions of images of the R, G, B signals projected respectively from the CRTs 30R, 30G, 30B onto the screen S are different from each other, there is raised a problem that thus; formed images are caused to be subject to distortion and color shift.

So as to correct such distortion and color shift of images, the triple-tube type CRT projector is provided with a registration apparatus. The registration apparatus is an apparatus adapted for correcting distortion and color shift of images by generating correction waveform signals and providing predetermined deflection yokes for registration of the respective CRTs with deflecting currents corresponding to thus generated correction waveform signals.

In the triple-tube type CRT projector, registration is adjusted under the process of a flow chart shown in FIG. 2. Firstly, in step S21, main deflection adjustment is performed to cause the respective CRTs to scan images based on horizontal synchronizing signals and vertical synchronizing signals. Then in step S22, coarse adjustment (mode for performing coarse adjustment is referred to as coarse adjustment mode) is performed to adjust distortion and color shift of whole images projected onto the screen S, and then in step S23, fine adjustment (mode for performing fine adjustment is referred to as fine adjustment mode) is performed to adjust distortion and color shift of images independently at plural adjustment points arranged on the screen S, by the registration apparatus respectively. Thus, as the registration adjustment or adjustment of registration, there are the coarse adjustment mode and the fine adjustment mode.

The triple-tube type CRT projector can process image signals supplied in various input video modes such as the NTSC (National Television System Committee) the PAL (Phase-Alternation Line), and the HDTV (High-Definition Television), and can also process image signals supplied in various image display modes, in which images can be displayed in different display configuration, such as the Full mode, the Zoom mode which enlarges predetermined parts of images, and the V (vertical) compression mode which displays images with their vertical components alone compressed.

In case correction waveform signals which are effective in performing registration adjustment in the Full mode of the NTSC are used in the V compression mode, being in synchronization with horizontal synchronizing signals and vertical synchronizing signals of image signals, the correction waveform signals are compressed along the vertical direction similar to the image signals and waveforms of the correction waveform signals corresponding to the CRT tube surface position are undesirably changed, as shown in FIG. 3A and FIG. 3B.

When considering the state based on time base, since a period of time required in scanning one field of the CRT tube surface by image signals is equal in the Full mode and in the V compression mode (scan time of 16.67 ms), the correction waveform signals themselves are the same.

Thus, a triple-tube type CRT projector provided with a conventional registration apparatus requires different correction waveform signals corresponding to the respective input modes, and the user has to perform registration adjustment under manual operation for each input mode, which undesirably requires a long period of time in performing registration adjustment.

### DISCLOSURE OF THE INVENTION

Accordingly, the present invention has an object to overcome the above-mentioned drawbacks of the prior art by providing an apparatus and a method for adjusting registration which can process image signals of different input modes, and can reduce a period of time required in performing registration adjustment.

The above object can be attained by providing an apparatus for adjusting registration, including storage means for storing correction data for deflection used to correct scanning positions of image signals for respective plural adjustment points arranged on a display screen along the horizontal direction and the vertical direction, interpolation scanning line-number determination means for determining the number of scanning lines which are scanned between the adjustment points corresponding to input image signals, and correction waveform signal generation means for inducing correction waveforms corresponding to display screen position based on the correction, data read out from the storage means, and performing interpolation calculation based on the number of scanning lines determined by the interpolation scanning line number determination means to generate current signals to be applied to deflection yokes.

Also, the above object can be attained by providing a method for adjusting registration, including the steps of storing correction data for deflection used to correct scanning positions of image signals for respective plural adjustment points arranged on a display screen along the horizontal direction and the vertical direction, determining the number of scanning lines which are scanned between the adjustment points corresponding to input image signal, and specifying correction waveforms corresponding to display screen position based on the correction data stored for the respective adjustment points, and performing interpolation calculation based on the number of scanning lines between the adjustment points to generate current signals to be applied to deflection yokes.

With above-described configuration, once a set of correction data for deflection of predetermined input state corresponding to input modes, image sizes, etc. is stored, correction waveform signals in view of time base to be applied to deflection yokes can be obtained by performing interpolation calculation based on the number of interpolation scanning lines specified according to the input state of image signals for correction waveforms corresponding to display screen position induced from the correction data. Thus, current waveforms to be applied to the deflection yokes can be obtained easily in a short period of time, and storage capacity required in storing the correction data can be reduced.

According to the apparatus for adjusting registration, the storage means stores correction data for coarse adjustment used to correct scanning positions of image signals over the whole display screen and correction data for fine adjustment used to correct scanning positions of image signals partially, and the apparatus further includes correction waveform superimposition means for superimposing correction waveforms obtained from the correction data for coarse adjustment and correction waveforms obtained from the correction data for fine adjustment.

According to the method for adjusting registration, the method further includes the steps of storing correction data for coarse adjustment used to correct scanning positions of image signals over the whole display screen for the respective adjustment points, storing correction data for fine adjustment used to correct scanning positions of image signals partially for the respective adjustment points, and superimposing correction waveforms obtained from the correction data for coarse adjustment and correction waveforms obtained from the correction data for fine adjustment to induce correction waveforms. With above-described configuration, more flexible registration adjustment for image signals can be possible when the coarse adjustment and the fine adjustment are combined, and complicated correction waveforms can be expressed with reduced data. Furthermore, interpolation calculation is performed after superimposing correction waveforms obtained from the correction data for coarse adjustment and corrections waveforms obtained from the correction data for fine adjustment and generating correction waveforms require in performing registration adjustment. Thus, the number of steps required for the calculation processing is minimized, and current waveforms can be obtained in a short period of time.

According to the apparatus and method for adjusting registration, the number of scanning lines between the adjustment points are periodically changed.

With above-described configuration, according to the present invention, it becomes possible to periodically change image size, which can prevent burn-in of CRTs.

### BRIEF DESCRIPTION OF THE DRAWINGS

FIG. 1 shows a schematic view for explaining a conventional triple-tube type CRT projector.

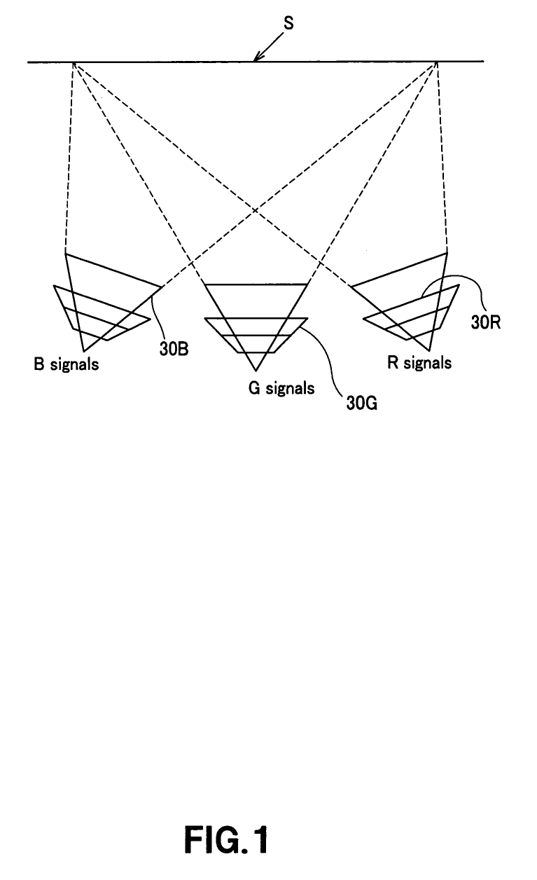

FIG. 2 shows a flow chart for explaining the processing of registration adjustment using the triple-tube type CRT projector.

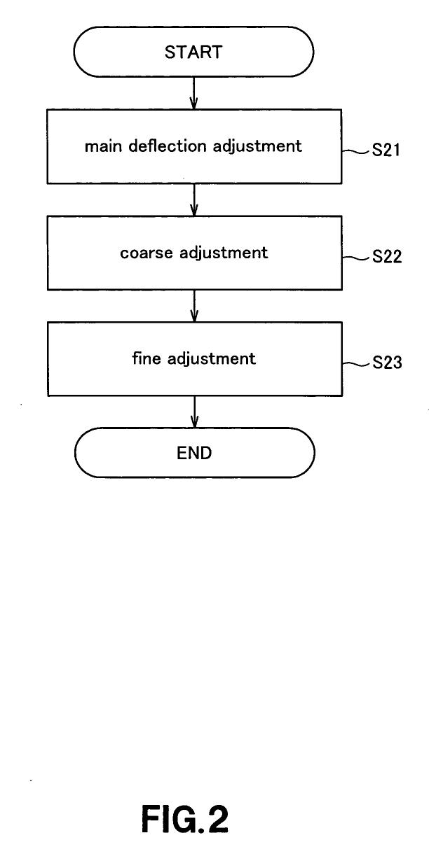

FIG. 3A and FIG. 3B show correction waveforms to be used in registration adjustment in the triple-tube type CRT projector.

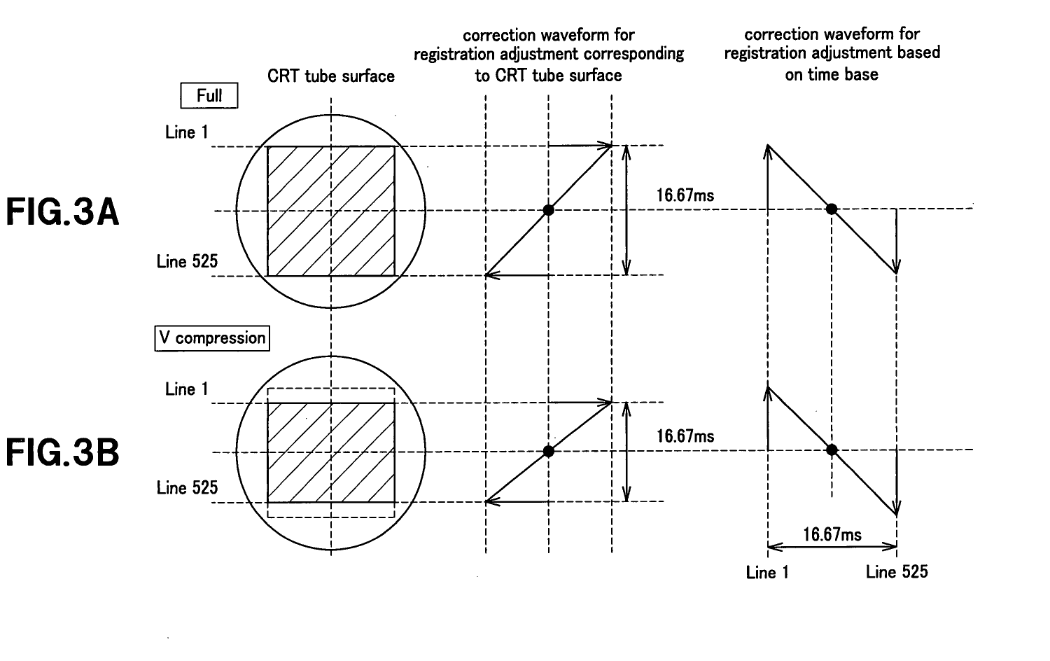

FIG. 4 shows a block diagram for explaining the configuration of a triple-tube type CRT projector of the present invention.

FIG. 5 shows a block diagram for explaining the configuration of a system IC of the triple-tube type CRT projector.

FIG. 6 shows correction waveform data for coarse adjustment stored in a coarse adjustment RAM of the triple-tube type CRT projector.

FIG. 7 shows correction waveform data for coarse adjustment stored in the coarse adjustment RAM of the triple-tube type CRT projector.

FIG. 8 shows a view for explaining adjustment points in the fine adjustment mode.

FIG. 9 shows a view for explaining storage areas of a fine adjustment RAM of the triple-tube type CRT projector.

FIG. 10A and FIG. 10B show correction waveforms to be used in registration adjustment in the triple-tube type CRT projector.

FIG. 11 shows a view for explaining the relation between the CRT tube surface and image signals projected onto a screen by the triple-tube type CRT projector.

FIG. 12 shows a view for explaining the processing of changing the number of interpolation lines between adjustment points in the triple-tube type CRT projector.

FIG. 13A and FIG. 13B show views for explaining the number of interpolation lines in different modes in the triple-tube type CRT projector.

FIG. 14 shows a view for explaining the difference of the number of interpolation lines between adjustment points on the CRT tube surface in the Full mode and in the V compression mode in the triple-tube type CRT projector.

FIG. 15 shows a flow chart for explaining the processing of registration adjustment using the triple-tube type CRT projector.

### BEST MODE FOR CARRYING OUT THE INVENTION

The apparatus and method for adjusting registration according to the present invention will further be described below concerning the best modes with reference to the accompanying drawings.

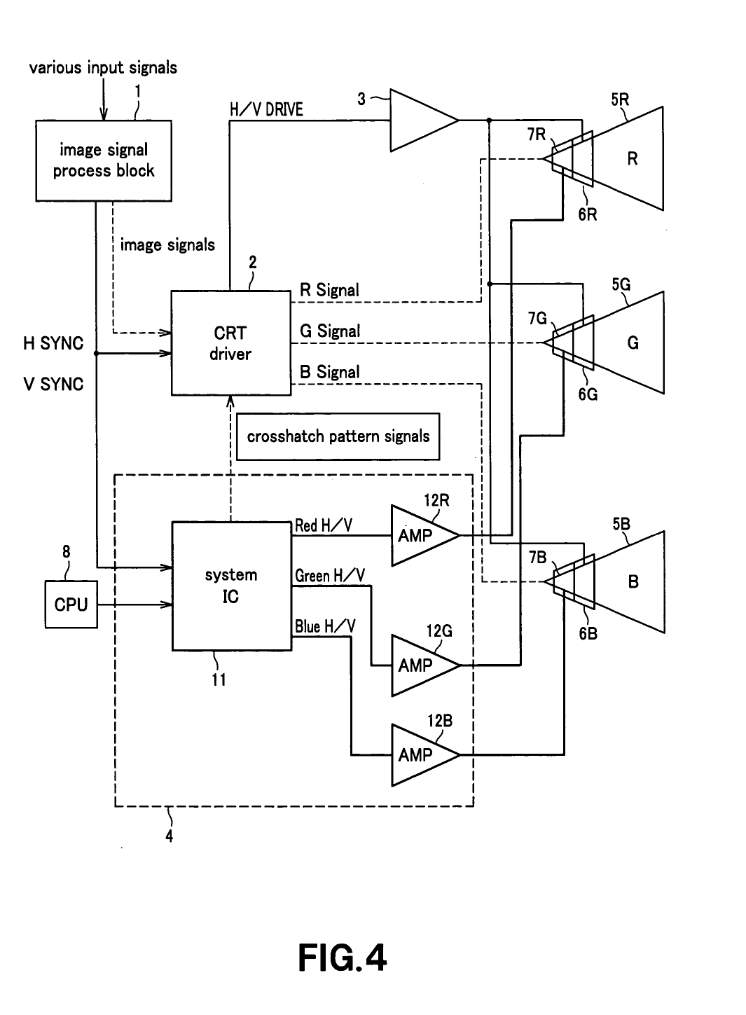

FIG. 4 shows a block diagram of a triple-tube type CRT projector using three Cathode-Ray Tubes (CRTs) to which the present invention is applied. The CRT projector is an apparatus for enlarging image signals supplied thereto and projecting thus enlarged image signals to a predetermined screen, etc.

The triple-tube type CRT projector includes an image signal process block 1, a CRT driver 2, a main deflection circuit 3, a registration adjustment circuit block 4 (referred to also as sub deflection block 4, hereinafter), a CRT 5R, a CRT 5G, a CRT 5B, and a CPU 8, as shown in FIG. 4. The CRTs 5R, 5G, 5B are Cathode-Ray Tubes each having a cathode electrode, not shown, to which three primary colors of R, G, B signals are supplied respectively, and neck parts of the CRTs 5R, 5G, 5B are provided with deflection yokes 6R, 6G, 6B respectively for deflecting supplied R, G, B signals to scan images. Furthermore, the cathode electrode sides, not shown, of the neck parts of the CRTs 5R, 5G, 5B are provided with sub deflection-yokes 7R, 7G, 7B for registration adjustment other than the deflection yokes 6R, 6G, 6B respectively. As will not be shown here, the deflection yokes 6R, 6G, 6B and sub deflection yokes 7R, 7G, 7B are provided with horizontal deflection coils and vertical deflection coils which form magnetic fields to deflect R, G, B signals supplied from the cathode electrodes, not shown, of the CRTs 5R, 5G, 5B respectively. So, when deflecting currents are applied to the horizontal deflection coils and the vertical deflection coils, the R, G, B signals are deflected to form scanning lines.

The image signal process block 1 divides predetermined input signals into synchronizing signals, which are composed of horizontal synchronizing signals (H) and vertical synchronizing signals (V), and image signals. The image signal process block 1 sends synchronizing signals composed of horizontal synchronizing signals (H) and vertical synchronizing signals (V) to the CRT driver 2 and to the sub deflection block 4, and sends image signals to the CRT driver 2. Image signals to be supplied to the image signal process block 1 are input video signals of the NTSC, PAL, HD, etc. The image signal process block 1 converts such input video signals to image signals of various image display modes such as the Full mode, V compression mode, and Zoom mode in accordance with demand of the user, and outputs thus converted image. signals.

The CRT driver 2 divides image signals sent from the image signal process block 1 into R signals, G signals, and B signals, and supplies the cathode electrodes, not shown, of the CRTs 5R, 5G, 5B with thus divided R, G, B signals respectively. Furthermore, the CRT driver 2 sends synchronizing signals composed of horizontal synchronizing signals (H) and vertical synchronizing signals (V) to the main deflection circuit 3.

The main deflection circuit 3 generates deflecting currents of horizontal period and vertical period such as sawtooth currents which are in synchronization with the horizontal synchronizing signals (H) and vertical synchronizing signals (V) sent from the CRT driver 2, and sends thus generated deflecting currents to the deflection yokes 6R, 6G, 6B of the CRTs 5R, 5G, 5B respectively. As will not be shown here, the main deflection circuit 3 has two output lines to supply the horizontal deflection coils and the vertical deflection coils of the deflection yokes 6R, 6G, 6B with the deflecting currents.

The registration adjustment circuit block (sub deflection block) 4 has a system IC 11, an amplifier 12R, an amplifier 12G, an amplifier 12B, and performs registration adjustment of the triple-tube type CRT projector. The registration adjustment is the processing to correct distortion and color shift of images projected by the triple-tube type CRT projector onto a screen, in which processing, correction waveform signals to correct distortion components etc. raised in images using R, G, B signals are generated, and thus generated correction waveform signals are supplied to the sub deflection yokes 7R, 7G, 7B of the CRTs 5R, 5G, 5B. The system IC II of the sub deflection block 4 generates correction waveform signals which are in synchronization with the horizontal synchronizing signals (H) and vertical synchronizing signals (V) sent from the image signal process block 1, and sends deflecting currents corresponding to the correction waveform signals to the sub deflection yokes 7R, 7G, 7B arranged at downstream stages thereof through the amplifiers 12R, 12G, 12B respectively. Since there are horizontal correction waveform signals in charge of horizontal correction processing and vertical correction waveform signals in charge of vertical correction processing as the correction waveform signals, the system IC 11 has six output lines to send deflecting currents, which are not shown. Furthermore, as will not be shown here, the horizontal synchronizing signals (H) and vertical synchronizing signals (V), which are sent from the image signal process block 1 to the system IC 11, may be sent from the main deflection circuit 3. Generation processing of the correction waveform signals by the system IC 11 will be explained later.

The system IC 11 has a crosshatch pattern generator, not shown, for generating crosshatch pattern signals used in performing registration adjustment. The crosshatch pattern generator generates crosshatch pattern signals under the control of the CPU 8 which receives predetermined indications from the user through a control panel, not shown, and sends thus generated crosshatch pattern signals to the CRT driver 2.

The amplifiers 12R, 12G, 12B amplify deflecting currents corresponding to supplied correction waveform signals, and sends thus amplified deflecting currents to the sub deflection yokes 7R, 7G, 7B. The sub deflection yokes 7R, 7G, 7B, which receive the deflecting currents perform registration adjustment by deflecting image signals to be supplied to cathode electrodes, not shown, of the CRTs 5R, 5G, 5B respectively corresponding to the deflecting currents. As will not be shown here, the amplifiers 12R, 12G, 12B have two output lines to supply deflecting currents to the horizontal deflection coils and the vertical deflection coils of the sub deflection yokes 7R, 7G, 7B respectively.

The CPU 8 is a control unit which comprehensively controls respective units of the triple-tube type CRT projector. The CPU 8 controls the system IC 11 of the sub deflection block 4 in accordance with indications from the user supplied through the control panel, not shown.

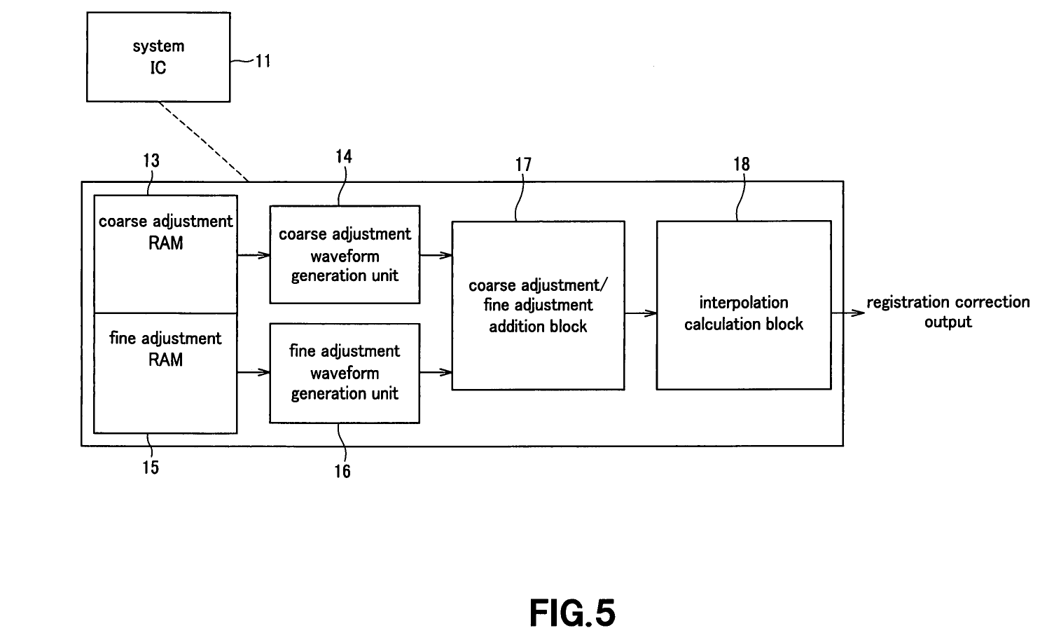

Next, with reference to FIG. 5, the configuration of the system IC 11 which generates the correction waveform signals for registration adjustment will be explained. The system IC 11 includes a coarse adjustment RAM 13, a coarse adjustment waveform generation unit 14, a fine adjustment RAM 15, a fine adjustment waveform generation unit 16, a coarse adjustment/fine adjustment addition block 17, and an interpolation calculation block 18.

As the registration adjustment, there are coarse adjustment mode to adjust distortion and color shift of whole images and fine adjustment mode to adjust distortion and color shift of images independently at predetermined adjustment points arranged along the horizontal direction and the vertical direction on a screen. In the triple-tube type CRT projector, the whole images undergo registration, adjustment under the coarse adjustment mode, and then undergo registration adjustment under the fine adjustment mode so as to compensate registration adjustment which cannot bee completed in the coarse adjustment mode.

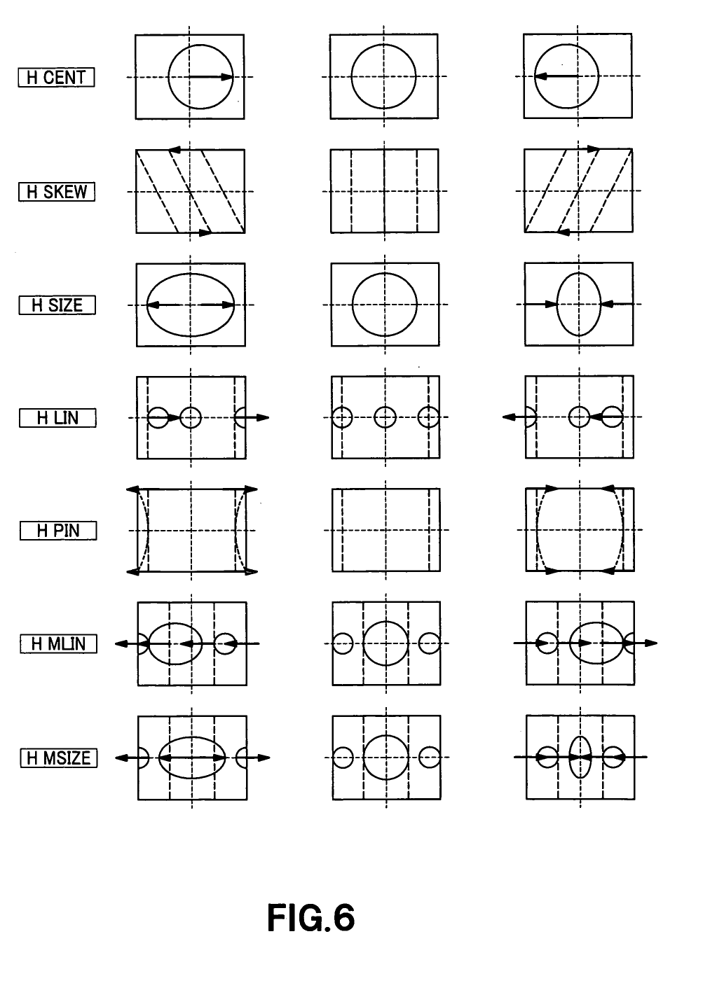

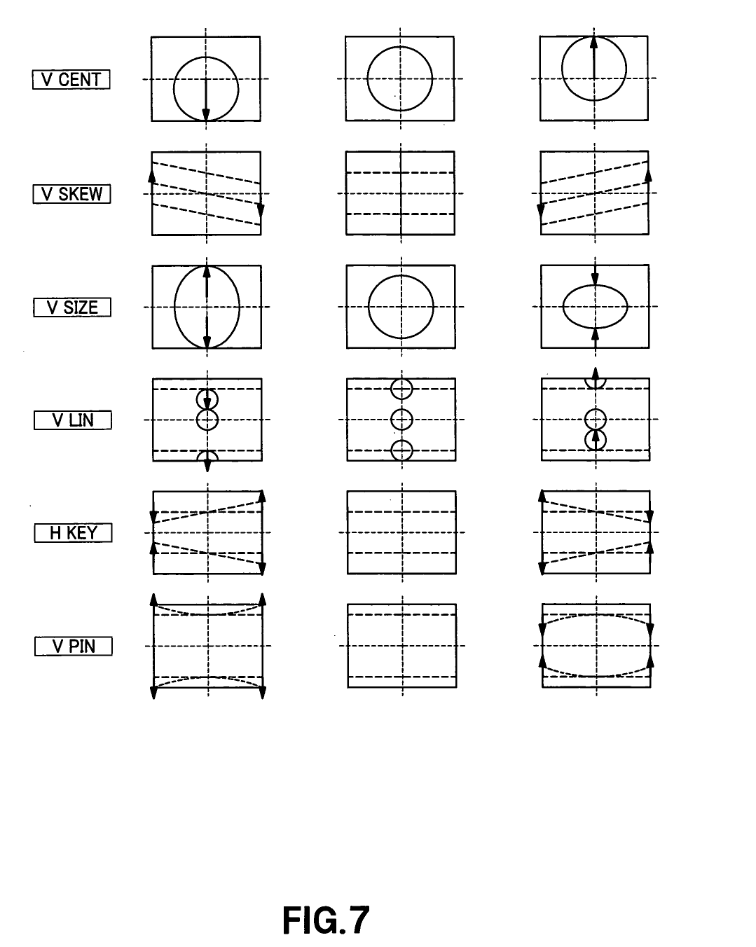

When registration adjustment is performed, correction waveform data for coarse adjustment corresponding to the R, G, B signals are written to the coarse adjustment RAM 13 by the CPU 8, and the coarse adjustment RAM 13 stores the correction waveform data for coarse adjustment. The correction waveform data for coarse adjustment stored in the coarse adjustment RAM 13 is waveform data corresponding to “H CENT” to adjust horizontal center, “H SKEW” to adjust horizontal skew distortion, “H SIZE” to adjust horizontal amplitude, “H LIN” to adjust horizontal linearity, “H PIN” to adjust horizontal pincushion distortion, “H MLIN” to adjust horizontal linearity of mid image, “H MSIZE” to adjust horizontal amplitude of mid image, “V CENT” to adjust vertical center, “V SKEW” to adjust vertical skew distortion, “V SIZE” to adjust vertical amplitude, “V LIN” to adjust vertical linearity, “V KEY” to adjust vertical keystone distortion, and “V PIN” to adjust vertical pincushion distortion, as shown in FIG. 6 and FIG. 7. The correction waveform data for coarse adjustment stored in the coarse adjustment RAM 13 is rewritten to be updated by the CPU 8 in accordance with indications from the user every time the registration adjustment is performed.

Also, the CPU 8 writes the correction waveform data for coarse adjustment stored in the coarse adjustment RAM 13 to an EEPROM. (Electrically Erasable Programmable Read-Only Memory), not shown, dedicated to the system IC 11 to store the same correction waveform data for coarse adjustment in the EEPROM. When turning off system power of the triple-tube type CRT projector, even though the correction waveform data for coarse adjustment stored in the coarse adjustment RAM 13 is deleted, the same correction waveform data for coarse adjustment is rewritten to the coarse adjustment RAM 13 from the EEPROM when the triple-tube type CRT projector is turned on.

The coarse adjustment waveform generation unit 14 generates correction waveform signal data for coarse adjustment from the correction waveform data for coarse adjustment read out from the coarse adjustment RAM 13.

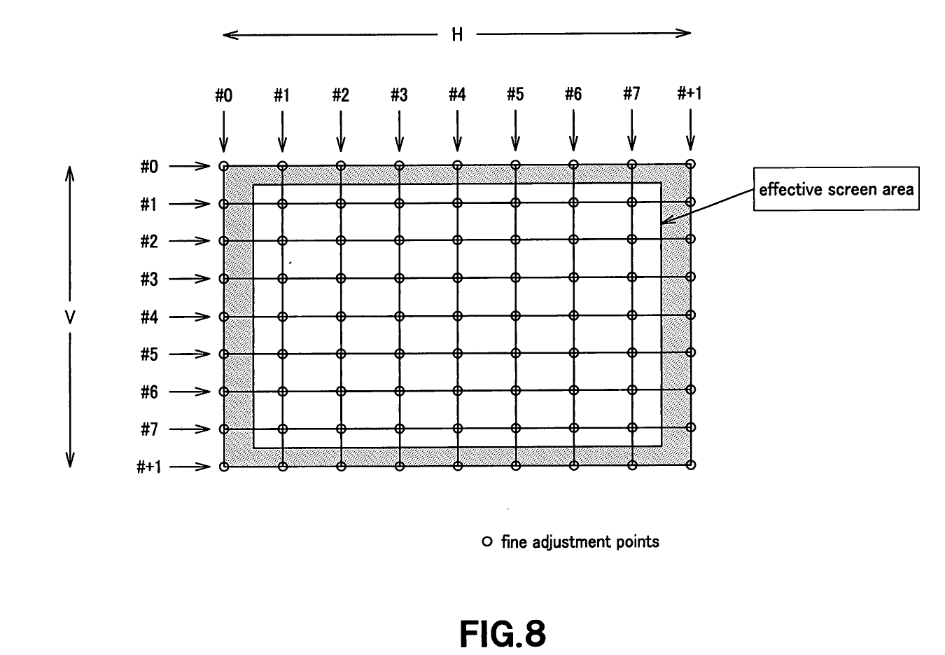

When registration adjustment is performed, correction waveform data for fine adjustment corresponding to the R, G, B signals are written to the fine adjustment RAM 15 by the CPU 8, and the fine adjustment RAM 15 stores the correction waveform data for fine adjustment. The correction waveform data for fine adjustment stored in the fine adjustment RAM 15 is correction waveform data at the total of 81 adjustment points which are located at intersections formed by horizontal nine lines and vertical nine lines, as shown in FIG. 8.

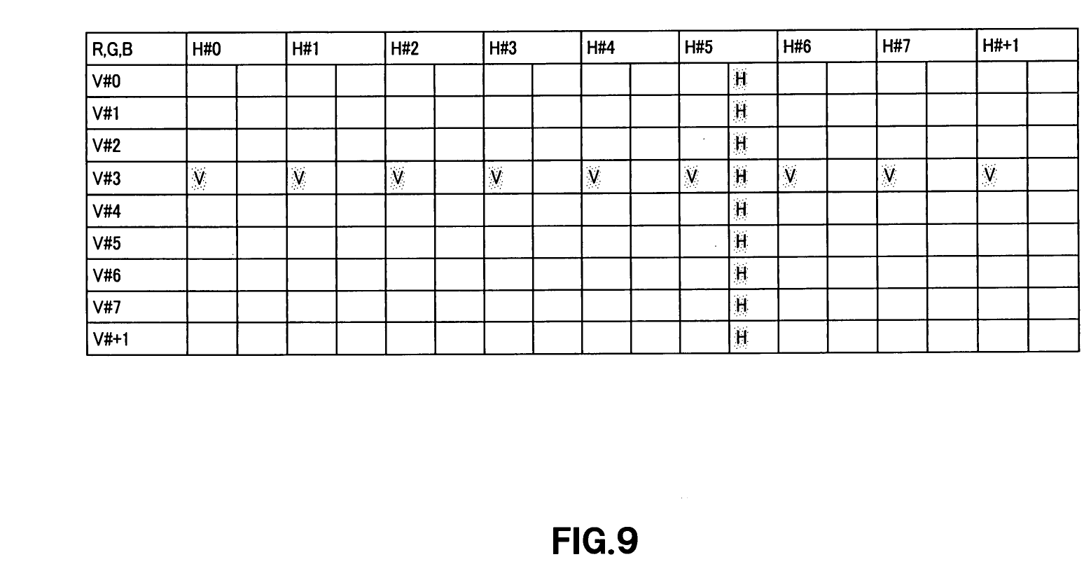

It is assumed that the total of 81 adjustment points are located on an screen, as shown in FIG. 8. The fine adjustment RAM 15 stores correction waveform data for fine adjustment corresponding to the horizontal synchronizing signals (H) and correction waveform data for fine adjustment corresponding to the vertical synchronizing signals (V) for the respective 81 adjustment points as shown in FIG. 9. Since the correction waveform data for fine adjustment are prepared for the R, G, B signals respectively, the fine adjustment RAM 15 has at least 81×2×3 independent storage areas secured therein. The correction waveform data for fine adjustment stored in the fine adjustment RAM 15 is rewritten to be updated by the CPU 8 in accordance with indications from the user every time the registration adjustment is performed.

Furthermore, the CPU 8 writes the correction waveform data for fine adjustment stored in the fine adjustment RAM 15 to an EEPROM (Electrically Erasable Programmable Read-Only Memory), not shown, dedicated to the system IC 11 to store the same correction waveform data for fine adjustment in the EEPROM. When turning off system power of the triple-tube type CRT projector, even though the correction waveform data for fine adjustment stored in the fine adjustment RAM 15 is deleted, the same correction waveform data for fine adjustment is rewritten to the fine adjustment RAM 15 from the EEPROM when the triple-tube type CRT projector is turned on.

The fine adjustment waveform generation unit 16 generates correction waveform signal data for fine adjustment from the correction waveform data for fine adjustment read out from the fine adjustment RAM 15.

The coarse adjustment/fine adjustment addition block 17, adds correction waveform signal data for coarse adjustment and correction waveform signal data for fine adjustment generated from the coarse adjustment waveform generation unit 14 and the fine adjustment waveform generation unit 16 respectively to generate added correction waveform signal data.

The interpolation calculation block 18 performs interpolation calculation for thus generated added correction waveform signal data to generate correction waveform signals, and supplies deflecting currents corresponding to thus generated correction waveform signals to the amplifiers 12R, 12G, 12B arranged at downstream stages thereof.

The principle of performing registration adjustment in the triple-tube type CRT projector of the present invention will be explained, in which, using correction waveform data which is used in performing registration adjustment for image signals of one input mode, registration adjustment for image signals of different input mode is performed.

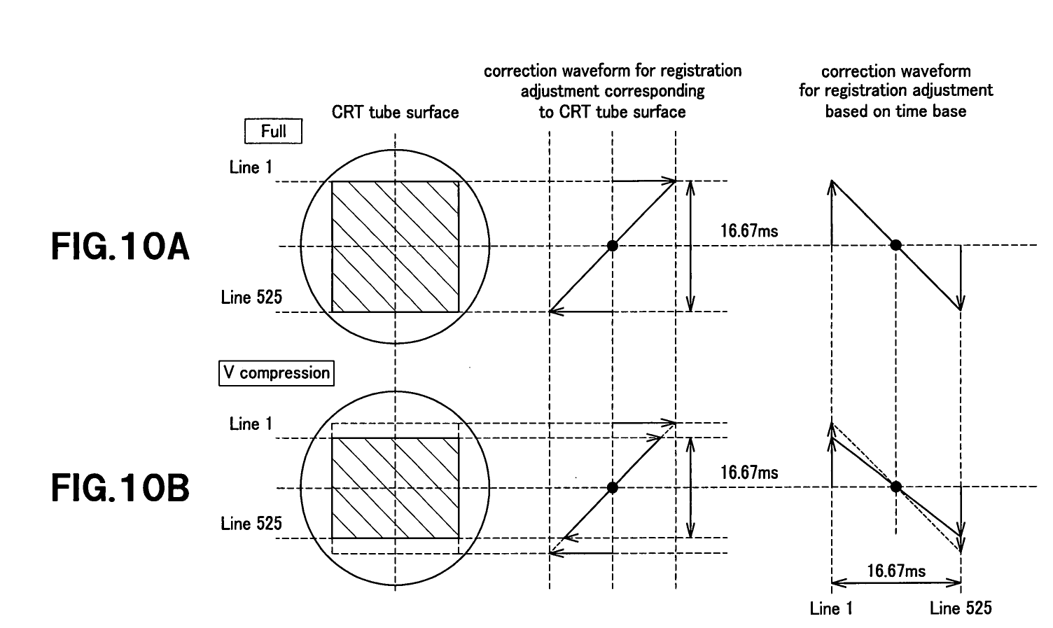

For example, it is assumed that the triple-tube type CRT projector performs registration adjustment in the Full mode of the NTSC, and that the relation between images scanned on the CRT tube surface and correction waveform signals are shown as FIG. 10A. In case image signals of the same NTSC are supplied to the image signal process block 1 of the triple-tube type CRT projector and are converted to image signals of the V compression mode, the relation between images scanned on the CRT tube surface and correction waveform signals are shown as FIG. 10B, and exact registration adjustment is performed by using a correction waveform shown in a continuous line being part of the same correction waveform of the correction waveform signals of the Full mode.

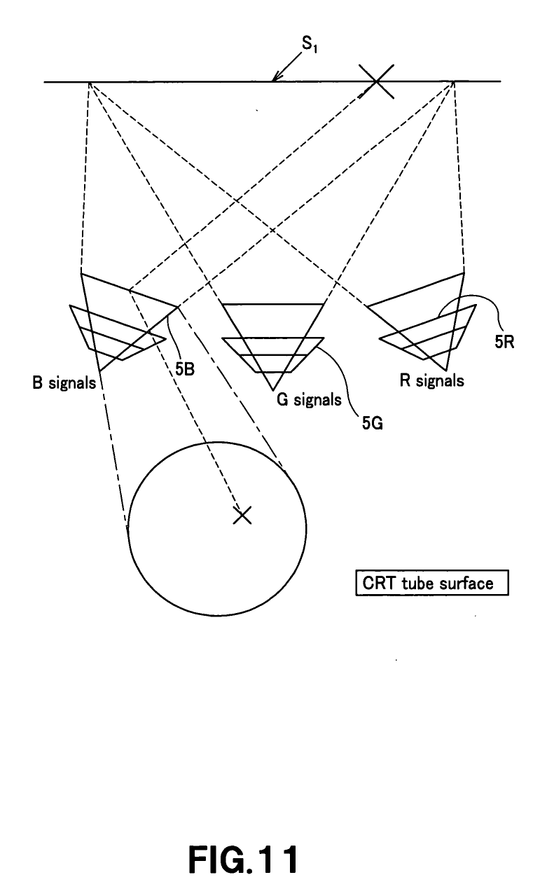

Image signals projected from one point of the CRT tube surface, for example a point marked with “×” of the CRT 5B, fall to one point of a screen S₁ biuniquely, as shown in FIG. 11. Thus, when a position of the CRT tube surface from which image signals are projected is determined, a position on the screen S₁ to which the image signals fall is determined. Accordingly, since the correction waveform signals for performing registration adjustment for image signals depend on a position of the CRT tube surface from which the image signals are projected, the relation of the correction waveforms shown in FIG. 10A and FIG. 10B can be seen.

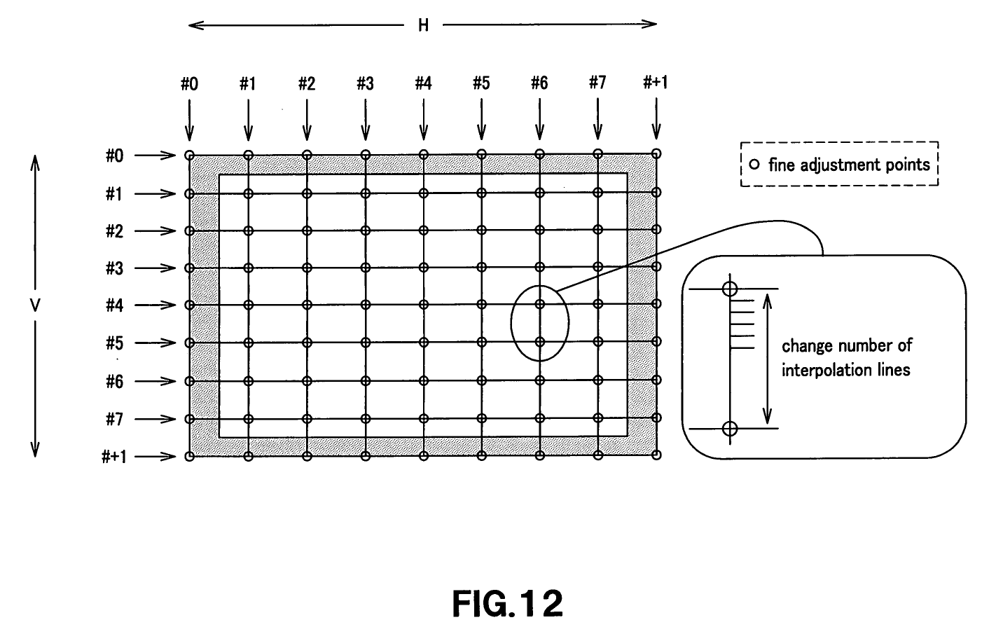

Performing registration adjustment shown in FIG. 10B using correction waveform data which is used in performing registration adjustment for image signals of the Full mode of the NTSC can be realized by changing the number of interpolation lines between adjustment points, as shown in FIG. 12.

For example, it is assumed that registration adjustment is performed for image signals of the Full mode of the NTSC with 525 scanning lines which are scanned to oblique-line-part of the CRT tube surface shown in FIG. 10A, and that the triple-tube type CRT projector stores correction waveform data corresponding to the Full mode of the NTSC in the coarse adjustment RAM 13 and in the fine adjustment RAM 15. In this case, in case the number of adjustment points is 81, the number of interpolation lines between adjustment points in the Full mode is 116.

Next, using the triple-tube type CRT projector, the case of performing registration adjustment for image signals of the V compression mode of the NTSC, which are generated by compressing image signals of the Full mode of the NTSC by ¾ along the vertical direction, to be scanned to oblique-line-part of the CRT tube surface shown in FIG. 10B, that is, image signals which have their main deflecting currents along the vertical direction converted by ¾ as compared with main deflecting currents of image signals of the Full mode will be considered.

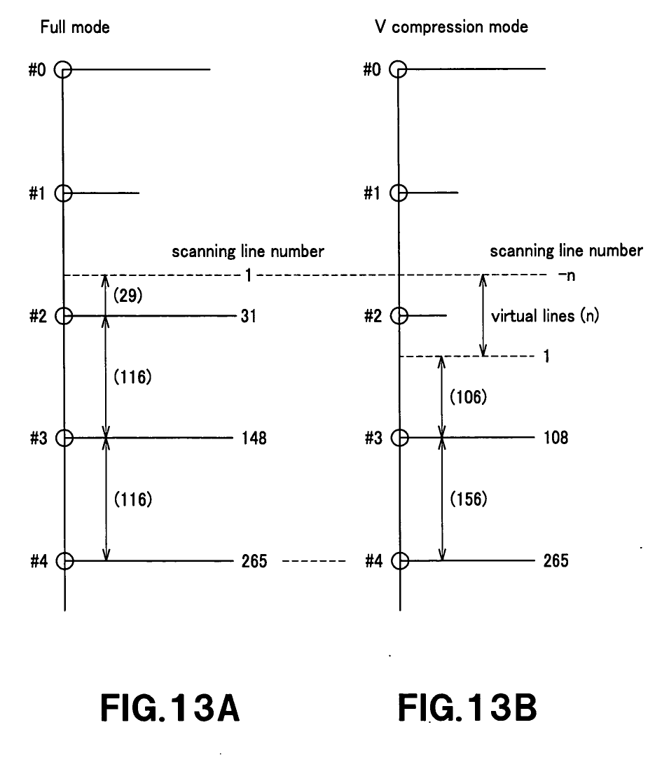

In case image signals of the Full mode of the NTSC supplied to the image signal process block 1 converted to image signals of the V compression mode the size of images along the vertical direction can be changed corresponding to the V compression mode by changing the number of interpolation lines between adjustment points from 16 in the Full mode shown in FIG. 13A to 156 shown in FIG. 13B.

Furthermore, in the V compression mode, correction waveform data at adjustment points required when scanning line number is “1” is correction waveform data at adjustment points of #2 and #3 along the vertical direction, as shown in FIG. 13B.

It is assumed that image signals which have their number of interpolation lines between adjustment points changed to 156 are supplied to the triple-tube type CRT projector to scan the scanning region on the CRT tube surface that image signals of the Full mode scan. That is, when image signals are converted to those of the V compression mode, scanning line number “-n” to “0” are assumed to be virtual lines, and the virtual lines are assumed to have been scanned already on the CRT tube surface. Thus, registration adjustment for the scanning line number “1” of image signals of the V compression mode is performed by using correction waveform data at adjustment points of #2 and #3 along the vertical direction.

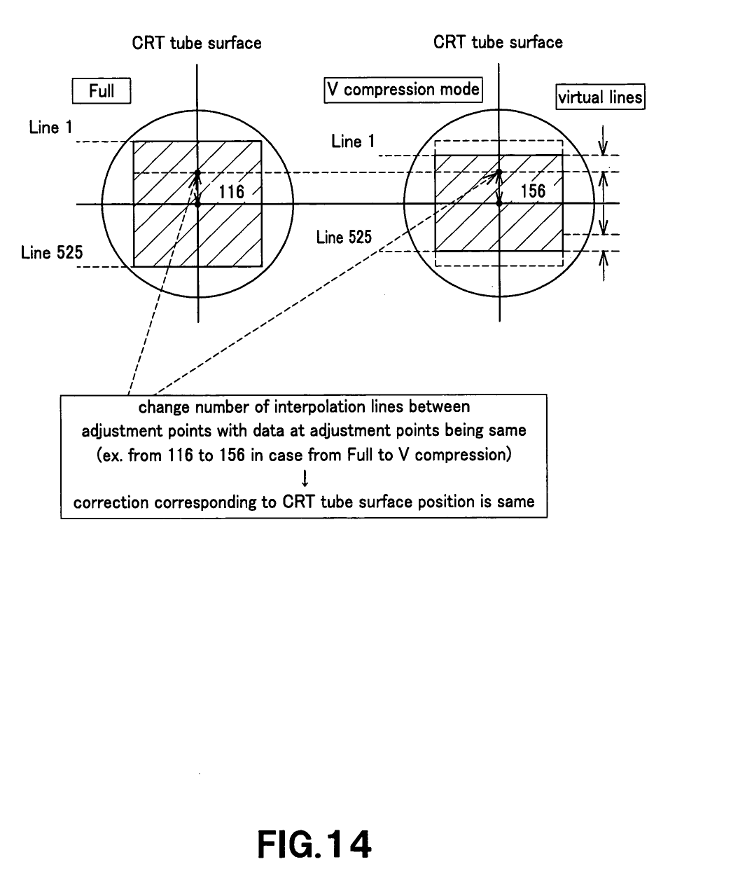

Furthermore, registration adjustment is performed for scanning lines between adjustment points by continuously performing interpolation calculation. When performing registration adjustment in the V compression mode using correction waveform data which is used in performing registration adjustment for image signals of the Full mode, in case adjustment points are determined as shown in FIG. 12, the correction waveform shown in FIG. 10B can be obtained by changing the number of interpolation lines between adjustment points from 116 to 156, as shown in FIG. 14.

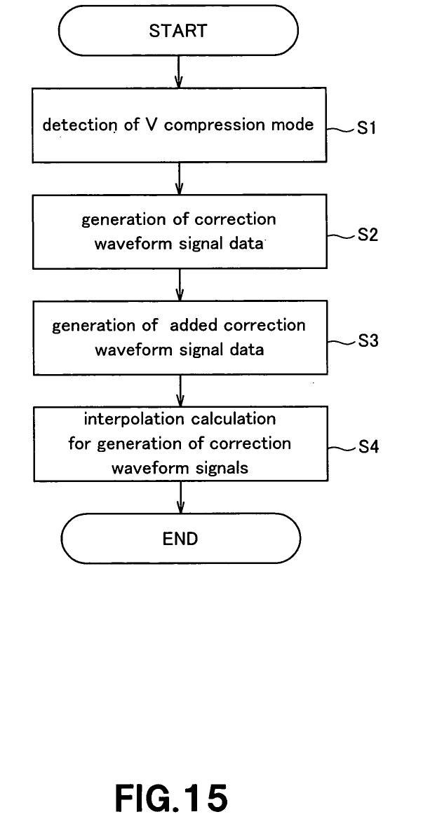

Next, the operation of the triple-tube type CRT projector according to the present invention in performing registration adjustment will be explained with reference to a flow chart shown in FIG. 15.

In the following explanation, it is assumed that registration adjustment is performed for image signals of the Full mode, and then registration adjustment is performed for image signals which are supplied to the image signal process block 1 and converted to image signals of the V compression mode. Thus, the coarse adjustment RAM 13 and the fine adjustment RAM 15 store correction waveform data for coarse adjustment and correction waveform data for fine adjustment respectively, which are used when performing registration adjustment for image signals of the Full mode. It is also assumed that there are 81 adjustment points, as shown in FIG. 12.

Firstly, in step S1 when horizontal synchronizing signals (H) and vertical synchronizing signals (V) of image signals which are converted from the Full mode to the V compression mode in the image signal process block 1 are sent to a logic unit of the system IC 11; the logic unit judges the input mode to be the V compression mode. When the input mode is judged to be the V compression mode, the number of interpolation lines between adjustment points is determined. The number of interpolation lines in the V compression mode is 156.

Then in step S2, in accordance with the judgement that the input mode is the V compression mode, the coarse adjustment waveform generation unit 14 and the fine adjustment waveform generation unit 16 are controlled, and correction waveform data for predetermined adjustment points are read out from the coarse adjustment RAM 13 and the fine adjustment RAM 15, respectively. Then, the coarse adjustment waveform generation unit 14 and the fine adjustment waveform generation unit 16 generates correction waveform signal data for coarse adjustment and correction waveform signal data for fine adjustment, respectively.

Then in step S3, the coarse adjustment/fine adjustment addition block 17 adds the correction waveform signal data for coarse adjustment and the correction waveform signal data for fine adjustment generated in step S2 to generate added correction waveform signal data.

Then in step S4, the interpolation calculation block 18 is controlled to generate correction waveform signals with the number of interpolation lines set to be 156 from the added correction waveform signal data generated in step S3.

The V compression mode is an input mode which has its size of images along the vertical direction compressed with the number of scanning lines being equal to that of the Full mode. On the other hand, other than this mode, image signals, of input video modes of the PAL and the HDTV whose number of scanning lines are larger than that of the NTSC as well as image signals of image display mode of the Zoom mode which enlarges vertical components, which processing is opposite to that of the V compression mode, can be coped with by suitably changing the number of interpolation lines between adjustment points.

As in the above, above-described explanation is about registration adjustment for image signals of different input mode which have their main deflecting currents along the vertical direction converted. On the other hand in case image signals of different input mode which have their main deflecting currents along the horizontal direction converted are supplied, the image signals can be coped with by changing the number of system clocks which correspond to the number of interpolation lines.

Furthermore, in the above-described explanation, the triple-tube type CRT projector of the present invention determines the number of interpolation lines between adjustment points corresponding to the input mode, and automatically and periodically changes image size of input image signals, and periodically changes the number of interpolation lines. accordingly to perform registration adjustment; which can prevent burn-in of CRTs.

As in the above, the present invention is applied to the triple-tube type CRT projector in the above-described explanation. On the other hand, the present invention is not restricted to the case, and the present invention can also be applied to a single-tube type CRT projector.

### INDUSTRIAL APPLICABILITY

According to the apparatus and method for adjusting registration of the present invention, since the number of scanning lines between adjustment points are periodically changed, it becomes possible to periodically change image size, which can prevent burn-in of CRTs.

1. An apparatus for adjusting registration, comprising:
storage means for storing correction data for deflection used to correct scanning positions of image signals for respective plural adjustment points arranged on a display screen along the horizontal direction and the vertical direction;
interpolation scanning line number determination means for determining the number of scanning lines which are scanned between the adjustment points corresponding to input image signals; and
correction waveform signal generation means for inducing correction waveforms corresponding to display screen position based on the correction data read out from the storage means, and performing interpolation calculation based on the number of scanning lines determined by the interpolation scanning line number determination means to generate current signals to be applied to deflection yokes.

2. The apparatus for adjusting registration as set forth in claim 1, wherein the storage means stores correction data for coarse adjustment used to correct scanning positions of image signals over the whole display screen and correction data for fine adjustment used to correct scanning positions of image signals partially, and further comprises correction waveform superimposition means for superimposing correction waveforms obtained from the correction data for coarse adjustment and correction waveforms obtained from the correction data for fine adjustment.

3. The apparatus for adjusting registration as set forth in claim 1, wherein the interpolation scanning line number determination means periodically changes the number of scanning lines between the adjustment points.

4. A method for adjusting registration, comprising the steps of
storing correction data for deflection used to correct scanning positions of image signals for respective plural adjustment points arranged on a display screen along the horizontal direction and the vertical direction;
determining the number of scanning lines which are scanned between the adjustment points corresponding to input image signals; and
specifying correction waveforms corresponding to display screen position based on the correction data stored for the respective adjustment points, and performing interpolation calculation based on the number of scanning lines between the adjustment points to generate current signals to be applied to deflection yokes.

5. The method for adjusting registration as set forth in claim 4, further comprising the steps of:
storing correction data for coarse adjustment used to correct scanning positions of image signals over the whole display screen for the respective adjustment points;
storing correction data for fine adjustment used to correct scanning positions of image signals partially for the respective adjustment points; and
superimposing correction waveforms obtained from the correction data for coarse adjustment and correction waveforms obtained from the correction data for fine adjustment to induce correction waveforms.

6. The method for adjusting registration as set forth in claim 4, wherein the number of scanning lines between the adjustment points are periodically changed.
